(19) United States
(12) Patent Application Publication
(10) Pub. No.: US 2016/0334814 A1
(43) Pub. Date: Nov. 17, 2016

(54) TEMPERATURE MEASUREMENT ON A SURFACE HEATER FOR A HOUSEHOLD APPLIANCE

(71) Applicant: BSH HAUSGERÄTE GMBH, München (DE)

(72) Inventors: Alexander Dinkel, Unterwoessen (DE); Sebastian Matzinger, Erharting (DE); Klemens Roch, Trostberg (DE); Philipp Schaller, Traunreut (DE)

(21) Appl. No.: 15/111,826

(22) PCT Filed: Jan. 21, 2015
(86) PCT No.: PCT/EP2015/051095

§ 371 Date: Jul. 15, 2016

(30) Foreign Application Priority Data
Jan. 30, 2014 (DE) 102014201640

(51) Int. Cl. G05D 23/20; F24C 7/08; F24C 7/06; G01K 7/34

(52) U.S. Cl. CPC G05D 23/2036; G01K 7/34; F24C 7/083; F24C 7/067

(57) ABSTRACT

A surface heater for a household appliance includes an electrically insulating insulation layer having a permittivity which changes as a function of temperature. At least one strip-shaped heat conductor is applied to the electrically insulating insulation layer, and at least one measuring electrode which is electrically insulated in relation to the at least one heat conductor is applied on a same side of the insulation layer as the heat conductor.

The invention relates to a surface heater for a household appliance, comprising at least one strip-shaped heat conductor that is applied to an electrically insulating insulation layer, the permittivity of which changes according to the temperature.

A known method of determining the temperature on a surface heater of a household appliance without an additional temperature sensor is to determine the capacitance between a heat conductor and an electrically conductive substrate, which are separated from one another by an electrically insulating insulation layer, the permittivity of which changes according to the temperature. The disadvantage of this method is that, between the heat conductor and the substrate, one pole of the capacitance (the heat conductor) is at mains voltage (e.g. 230 V) and the other pole (the substrate) is grounded. This makes a number of demands on the measuring technology. Thus the measuring technology must be dimensioned so that it is not damaged by this electrical potential. The measuring technology must also, in accordance with the pertinent safety standards (e.g. EN60335), have a resistance to high voltages of at least 1000 V.
The leakage current between heat conductor and ground may in addition not be increased above the permitted limit value. According to EN60335-2-6 (for ranges and ovens), a limit for the leakage current amounts to 1 mA per kW of power. These requirements can be circumvented by the substrate being insulated from ground, whereby a “contact protection” is required however. These requirements can also be circumvented by the measurement technology being disconnectable and only being connected alternately with the heating power. Both cases require a significant outlay, which entails significant costs.

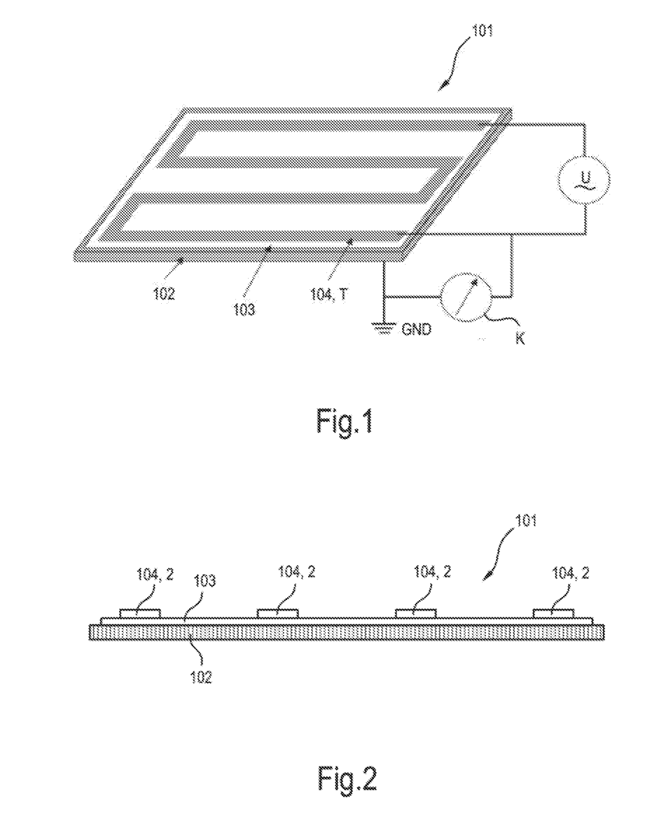

FIG. 1 shows an oblique view of such a surface heater 101, in which a strip-shaped metallic carrier substrate 102 is occupied on one side over its entire surface by an electrically insulating insulation layer 103. The carrier substrate 102 is in contact with ground GND. FIG. 2 shows the surface heater 101 as a cross-sectional diagram in a view from the front. Applied to the side of the insulation layer 103 facing away from the carrier substrate 102 is a strip-shaped layered heat conductor 104 running in a serpentine pattern. A mains voltage U can be applied to the layered heat conductor 104 to generate heat. By means of a capacitance measurement device K the capacitance C of a capacitor 102, 103, 104 is measured, one pole of which corresponds to the layered heat conductor 104 and the other pole of which corresponds to the carrier substrate 102. The insulation layer 103 corresponds to the dielectric of the capacitor 102-104, which has a permittivity that changes according to the temperature. To this end the capacitance measuring device K is connected electrically on one side to the layered heat conductor 104 and on the other side to the carrier substrate 102. If the temperature T of the layered heat conductor 104 changes, the temperature of the insulation layer 103 and thus also its permittivity changes. The changing permittivity causes a change in the capacitance C(T) of the capacitor 102-104, which is able to be measured by the capacitance measuring device K. By means of evaluation unit (not shown), which is connected to an output of the capacitance measuring device K, the temperature of the insulation layer 103 can be determined from this and thus, with only negligible deviation, also the temperature T of the layered heat conductor 104. The capacitance measuring device K and the evaluation unit can be parts or functions of a temperature measuring device.

It is also known that the temperature can be determined by means of measuring an electrical resistance of the heat conductor, if this is temperature-dependent.

The object of the present invention is to overcome the disadvantages of the prior art, at least in part, and in particular to provide an improved possibility of temperature measurement without an additional temperature sensor on a surface heater for a household appliance.

The object is achieved in accordance with the features of the independent claims. Preferred forms of embodiment are especially to be taken from the dependent claims.

The object is achieved by a surface heater for a household appliance, having at least one heat conductor applied to an electrically insulating insulation layer, the permittivity of which changes according to the temperature, wherein at least one measuring electrode electrically insulated in relation to the at least one heat conductor is applied to the same side of the insulation layer as the heat conductor.

The object is also achieved by a temperature measuring device for a surface heater in accordance with one of the preceding claims, which temperature measuring device has or is a capacitance measuring device, wherein the capacitance measuring device is connected to at least one measuring electrode.

Both facilities make possible a temperature-dependent capacitance measurement at the surface heater, wherein using the at least one heat conductor as a pole of a capacitor with its disadvantages is avoided, in particular the capacitance measuring device is insulated in relation to mains voltage. There are no requirements in relation to a leakage current or resistance to high-voltage. In addition at least one measuring electrode can be connected to the capacitance measuring device, which is electrically insulated from the heat conductor, but is able to be positioned through the arrangement on the same side of the insulation layer close enough to the at least one heat conductor for a precise determination to be possible.

A development is that the measuring electrodes (including the counter measuring electrode) are voltage-free, in order to make possible an accurate measurement with especially simple means.

The at least one heat conductor could especially have at least one layer-type heat conductor, e.g. a thick-layer heat conductor. This makes possible a compact design and a firm connection of the heat conductor to the insulating material. The at least one heat conductor could be applied by means of plasma coating for example.

The at least one heat conductor could especially be a metallic heat conductor. The at least one heat conductor could also have carbon nanotubes, CNT. The at least one heat conductor could also consist of electrically conductive ceramic. The at least one heat conductor could further be a PEMS (Porcelain Enamel Metal Substrate) heat conductor.

The at least one heat conductor could especially be a strip-shaped heat conductor. This makes possible a high degree of coverage of the heat conductor and in a simple manner a versatile design.

A development is that the at least one heat conductor is embodied as a heat conductor running in a serpentine shape. This makes possible an especially high degree of coverage of the heat conductor and an even heating of the surface. The heat conductor running in a serpentine shape could especially be a heat conductor of which the direction of curvature changes regularly. In particular this could be understood as a course in which straight-line sections alternate with e.g. U-shaped curved or straight-line connecting sections, so that at least two straight-line sections run in parallel at a distance from one another.

The insulation layer could be a closed or uninterrupted insulation layer, to which the at least one heat conductor is applied. This simplifies manufacturing, especially since the heat conductor is able to be positioned freely on the insulation layer. An advantageous alternate embodiment for saving insulating material is that the insulation layer essentially is only located below the at least one heat conductor and in this embodiment is somewhat wider than the heat conductor. Such an insulation layer at least predominantly follows the shape of the at least one heat conductor.

The measuring electrode (including a counter measuring electrode) could consist of the same material as the heat conductor, which makes manufacturing easier. As an alternative the measuring electrode could consist of a different material from the heat conductor, e.g. of another metal, especially to achieve a more precise capacitance measurement.

The capacitance measuring device could be connected with one measuring terminal to precisely one measuring electrode. As an alternative the capacitance measuring device could be connected, for combinational temperature measurement, to a number of points of the surface heater and thus, to avoid measurement outliers, with one measuring terminal to a number of measuring electrodes in parallel.

A further embodiment is that the measuring electrode is a strip-shaped or straight ban-shaped measuring electrode, which is disposed in an area between two sections of the heat conductor running in parallel. This means that the measuring electrode is located on an evenly heated area of the insulation layer, which improves measuring accuracy. The heat conductor could especially be a heat conductor running in a serpentine shape.

One embodiment is that at least two measuring electrodes are present on the surface heater and the capacitance measuring device is switched between two of the measuring electrodes. The two measuring electrodes thus serve as the poles (as measuring electrode or as counter measuring electrode) for the capacitance measurement, which are separated from one another by the insulation layer. This embodiment can be implemented especially easily. The capacitance measuring device can be connected at each measuring terminal to one measuring electrode in each case, i.e. can measure the capacitance between precisely two measuring electrodes as the poles, or can be connected at at least one measuring terminal to more than one measuring electrode, especially to at least two measuring electrodes switched electrically in parallel.

Another embodiment is that the surface heater has at least one counter measuring electrode separated from the at least one heat conductor and from the at least one measuring electrode by means of the insulation layer. This enables the capacitance measuring device to be connected on the one side to at least one measuring electrode and on the other side to at least one counter measuring electrode separated therefrom by means of the insulation layer. The capacitance measuring device can thus measure the capacitance of the insulation layer by electrodes disposed, especially in contact with opposite sides of the insulation layer. This could deliver an especially accurate measuring result. The at least one counter measuring electrode is likewise electrically insulated from the at least one heat conductor.

A further embodiment is that the at least one heat conductor is applied over the insulation layer to a planar, electrically conductive carrier substrate and that the carrier substrate is provided as a counter measuring electrode. This produces an especially stable embodiment of the surface heater. In addition the capacitance measuring device can be connected to the counter measuring electrode in a simple manner in this way. The carrier substrate could be a metallic substrate for example.

Another embodiment is that the insulting layer is embodied as an electrically insulating carrier substrate, e.g. of glass, glass ceramic or ceramic, especially as a plate. This makes further possible applications of the surface heater possible, for example if, in addition or as an alternative to the insulation characteristic, an especial hardness, transparency or translucence etc. is desired. The carrier substrate can then serve as the insulation layer or as the dielectric of the capacitor measured by the capacitance measuring device.

A development is that the heat conductor, if an electrically insulating carrier substrate is present, is in direct contact with the carrier substrate. This could simplify manufacturing, since a separate insulation layer can be dispensed with.

A further embodiment is that at least one counter measuring electrode is disposed on a side of the electrically insulating carrier substrate facing away from the heat conductor. This enables the changing permittivity of the carrier substrate to be detected in an especially simple and precise way.

As an alternative the capacitance could be determined here by measuring electrodes disposed on the same side of the carrier substrate.

Another embodiment is that the at least one heat conductor is applied over the insulation layer to a side of a planar, electrically conductive layer intended as a counter measuring electrode, which layer is disposed with its other side on an electrically insulating carrier substrate. In this case the insulation layer serves as the dielectric, not the carrier substrate. This has the advantage that characteristics of the insulation layer, e.g. its material or thickness, can be chosen explicitly to obtain an especially high measuring accuracy of the capacitance and/or for an especially reliable measurement.

Yet another embodiment is that at least one electrically conductive contact element for electrical contacting of a counter measuring electrode able to be placed on this side of the carrier substrate is let into the side of the electrically insulating carrier substrate, which faces away from the at least one heat conductor. The counter measuring electrode is thus not a fixed component of the surface heater, but is an object able to be handled separately therefrom, electrically conductive at its surface in contact with the contact element. The object could especially be an object usually able to be handled by a user of the household appliance, especially an at least electrically conductive object on the carrier substrate. The object could especially be a cooking utensil, especially cookware. In particular the carrier substrate could also especially serve as the dielectric for a capacitor, one pole of which is formed by at least one measuring electrode disposed on the carrier substrate and the other pole of which is formed by the object able to be placed on the user side, especially cooking utensils, serving as the counter measuring electrode. By means of the contact element the object can be electrically contacted and thereby connected to the capacitance measuring device. The contact element and also its electrical connecting line to the capacitance measuring device are electrically insulated in relation to the heat conductor.

Basically the temperature measuring device could also represent a part of the surface heater or be seen as such a part. In particular the at least one (counter) measuring electrode could represent both an integral part of the surface heater and also a part of the temperature measuring device.

The object is also achieved by a household appliance with at least one system comprising at least one surface heater as described above and at least one temperature measuring device as described above.

The household appliance could especially be a cooking appliance, but is not restricted thereto. If the household appliance is a cooking appliance, the surface heater could be used in an oven for example, e.g. as a top heater, bottom heater, recirculating heater, oven space divider, heated accessory etc. The surface heater could also be employed for example as a heater for steam generation in steam cooking appliances. Furthermore its application as a hotplate for conventional cooktops is possible, but also for Teppanyaki cookware, warming plates, table grills etc.

The surface heater can also be used in other types of household appliance, e.g. in laundry care appliances (e.g. in washing machines and/or tumble dryers), in dishwashers (e.g. to heat the washing liquid) or in small household appliances such as water boilers, coffee machines, hair straighteners, kitchen machines etc.

The characteristics, features and advantages of this invention described above as well as the manner in which these are achieved, will become clearer and easier to understand in conjunction with the following schematic description of exemplary embodiments, which are explained in greater detail in conjunction with the drawings. In said drawings, for improved clarity, the same elements or elements with the same effect can be provided with the same reference characters.

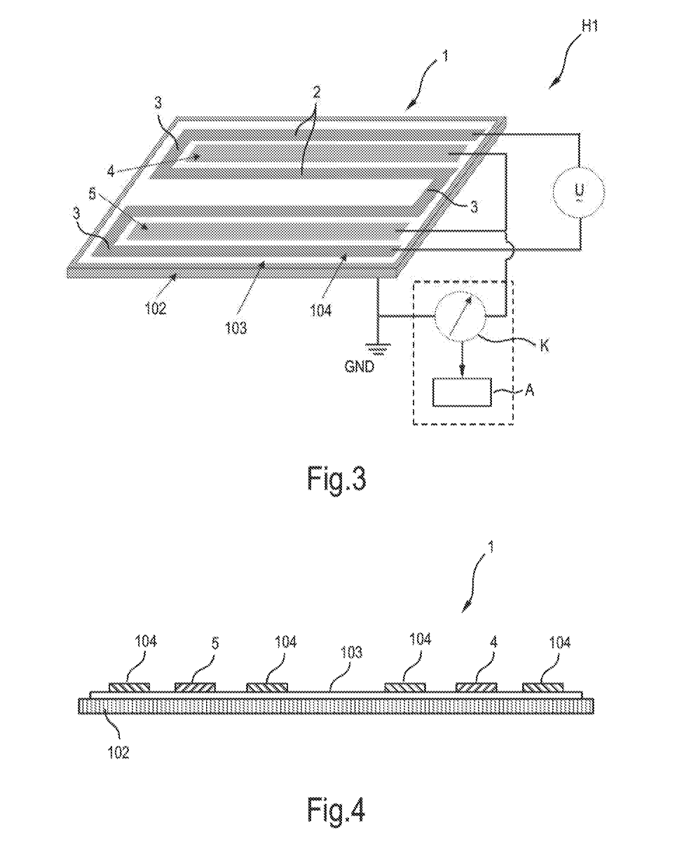

FIG. 3 shows an oblique view of an inventive surface heater with associated capacitance measuring device in accordance with a first exemplary embodiment;

FIG. 4 shows the surface heater in accordance with a first exemplary embodiment as a cross-sectional diagram viewed from the front;

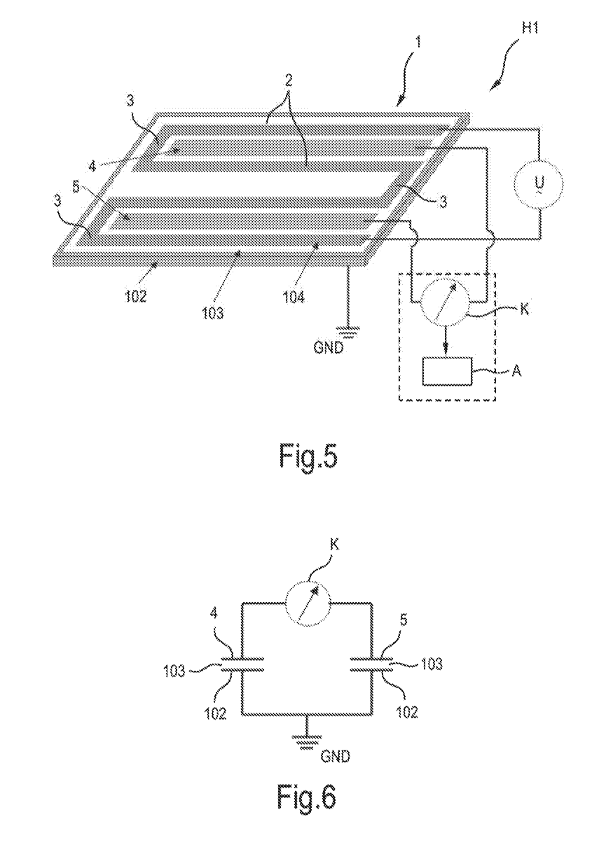

FIG. 5 shows an oblique view of an inventive surface heater with associated capacitance measuring device in accordance with a second exemplary embodiment;

FIG. 6 shows an equivalent circuit diagram of a surface heater and the associated capacitance measuring device in accordance with the second exemplary embodiment;

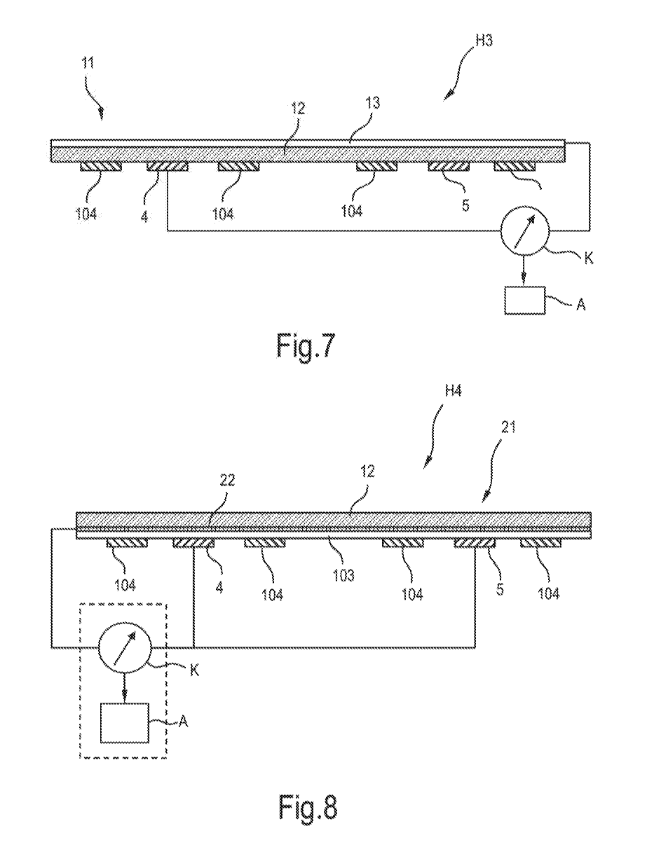

FIG. 7 shows the surface heater in accordance with a third exemplary embodiment as a cross-sectional diagram viewed from the front;

FIG. 8 shows the surface heater in accordance with a fourth exemplary embodiment as a cross-sectional diagram viewed from the front;

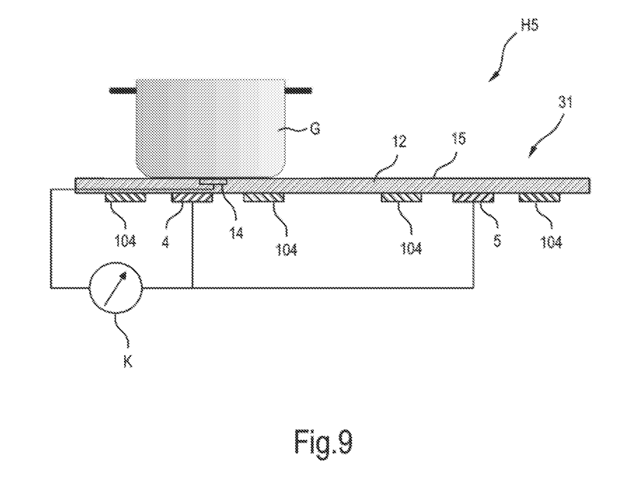

FIG. 9 shows the surface heater in accordance with a fifth exemplary embodiment as a cross-sectional diagram viewed from the front;

FIG. 3 shows an oblique view of an inventive surface heater 1 with associated capacitance measuring device K in or for a household appliance H1 in accordance with a first exemplary embodiment. The surface heater 1 is constructed in a similar way to the surface heater 101 and likewise has a strip-shaped metallic carrier substrate 102 for example, which is occupied on one side over its surface by an electrically insulating insulation layer 103. Applied on the side of the insulation layer 103 facing away from the carrier substrate 102 is likewise a strip-shaped layered heat conductor 104 running in a serpentine shape, to which for generating heat, a mains voltage U, e.g. of 230 Volts, can be applied. FIG. 4 shows the surface heater 1 as a cross-sectional diagram through straight-line heat conductor sections 2 of the layered heat conductor 104 in a view from the front. The straight-line heat conductor sections 2 are disposed in parallel at a distance from one another, wherein neighboring straight-line heat conductor sections 2 are connected to each other on their end side by connecting sections 3 lying transverse thereto.

By contrast with the surface heater 101, the surface heater 1 has two strip-shaped, straight measuring electrodes 4, 5, which are disposed in each case in parallel on the insulation layer 103 between two neighboring straight heat conductor sections 2 of the layered heat conductor 104. The measuring electrodes 4, 5 are electrically insulated from the layered heat conductor 104 and are potential-free or voltage-free. The material of the measuring electrodes 4, 5 could correspond to the material of the layered heat conductor 104, which allows easier manufacturing, for example by application in the same working step, e.g. by plasma deposition. The material of the measuring electrodes 4, 5 could also be a different, lower-cost material from the material of the layered heat conductor 104. The measuring electrodes 4, 5 preferably consist of the same material and are preferably also otherwise constructed in the same manner

The capacitance measuring device K is now connected on one side both to the measuring electrode 4 and also to the measuring electrode 5 and on the other side to the metallic carrier substrate 102 which is at ground GND. The carrier substrate 102 consequently serves as counter measuring electrode. The measuring electrodes 4, 5 together form a pole 4, 5 of a capacitor 4, 5, 103, 102, which improves measuring accuracy. Basically however only one measuring electrode 4 or 5 could be connected to the capacitance measuring device K, or there could also be more than two measuring electrodes connected to a common measuring terminal of the capacitance measuring device K, especially connected electrically in parallel. Since the insulation layer 103 has a permittivity that changes according to the temperature, the capacitance C(T) of the capacitor 4, 5, 103, 102 will change according to the temperature, from which the temperature in the insulation layer 103 or on the heat conductor 104 is able to be determined, e.g. by means of an evaluation unit A. The evaluation unit A could be coupled to the capacitance measuring device K and could be implemented for example as a function of a central control device. The evaluation unit A and the capacitance measuring device K could represent parts or functions of a temperature measuring device K. Since the measuring electrodes 4, 5 are located close to the layered heat conductor 104, a more accurate temperature measurement can be achieved.

FIG. 5 shows an oblique view of a surface heater 1 with associated capacitance measuring device K in or for a household appliance H2 in accordance with a second exemplary embodiment. The surface heater H1 and the capacitance measuring device K of the second exemplary embodiment have the same construction as those of the first exemplary embodiment, but are connected differently. FIG. 6 shows an equivalent circuit diagram of the surface heater and the associated capacitance measuring device K in accordance with the second exemplary embodiment.

The capacitance measuring device K is now connected on one side to the measuring electrode 4 and on the other side to the measuring electrode 5, which each form poles of a capacitor 4, 5, 103, 102 with the carrier substrate 102 as common counter pole. The capacitance is measured here between a measuring electrode 4 via the insulation layer 103, the carrier substrate 102 and once again the insulation layer 103 to the measuring electrode 5. This also allows a precise temperature measurement to be achieved. In addition the capacitance measuring device K is now even galvanically isolated from the supply voltage.

FIG. 7 shows a surface heater 11 with associated capacitance measuring device K in or for a household appliance H3 in accordance with a third exemplary embodiment. The surface heater 11 now has a strip-shaped, electrically insulating carrier substrate 12, made of glass, ceramic or glass ceramic for example. The layered heat conductor 104 and the measuring electrodes 4, 5 are in direct contact with the carrier substrate 12. The side of the carrier substrate 12 facing away from the layered heat conductor 104 and the measuring electrodes 4, 5 is provided with an electrically conductive layer, especially a metallization 13, which serves as counter measuring electrode. The capacitor is consequently formed by at least one of the measuring electrodes 4, 5 as a first pole, the carrier substrate 12 as the dielectric and the metallization 13 as the other pole. The capacitance measuring device K is consequently connected on one side to at least one of the measuring electrodes 4, 5 and on the other side to the metallization 13. The metallization could be connected to ground GND. This exemplary embodiment has the advantage of an especially simple and robust construction.

FIG. 8 shows a surface heater 21 with associated capacitance measuring device K in or for a household appliance H4 in accordance with a fourth exemplary embodiment. The surface heater 21 has a strip-shaped, electrically insulating carrier substrate 12, made of glass, ceramic or glass ceramic for example. This could represent an upper side or outer side of the household appliance H4 for example, e.g. serve as a cooktop plate of a household appliance H4 embodied as a cooktop.

By contrast with the surface heater 11, the layered heat conductor 104 and the measuring electrodes 4, 5 are not in direct contact with the carrier substrate 12, but with a planar insulation layer 103. In order to provide a counter measuring electrode, an electrically conductive intermediate layer 22 is provided between the carrier substrate 12 and the insulation layer 103, which can e.g. be equivalent to the metallization 13. The intermediate layer 22 could be connected to ground GND. This exemplary embodiment has the advantage that the material of the carrier substrate 12 does not need to be selected in respect of a sufficient temperature dependency. This increases a choice of materials, e.g. in respect of strength, fracture toughness, resistance, color etc. The insulation layer 103 could be chosen in respect of a good capacitance measurement for example.

FIG. 9 shows a surface heater 31 with associated capacitance measuring device K in or for a household appliance H5 in accordance with a fifth exemplary embodiment. The surface heater 31 has a strip-shaped, electrically insulating carrier substrate 12, made of glass, glass ceramic or ceramic for example. This could represent an upper side or outer side of the household appliance H5 for example, e.g. serve as a cooktop of a household appliance H5 embodied as a hob.

As with the surface heater 11, the layered heat conductor 104 and the measuring electrodes 4, 5 lie directly on the carrier substrate 12. A counter measuring electrode however is not part of the surface heater 31. In order to still provide a counter measuring electrode for capacitance measurement, in the upper side 15 of the carrier substrate 12 facing away from the layered heat conductor 104 and the measuring electrodes 4, 5, at least one electrically conductive contact element 14 is let in flush with the surface for contacting a cooking utensil G, e.g. a pot or a pan. In this exemplary embodiment use is made of the fact that the cooking utensil rests with a large surface area on the carrier substrate 12 and can thereby serve as a counter measuring electrode. The capacitance measuring device K is consequently connected on one side to at least one of the measuring electrodes 4, 5 and on the other side to at least one contact element 14 and thus also to the cooking utensil G.

Naturally the present invention is not restricted to the exemplary embodiments shown.

Thus measuring electrode(s) and counter measuring electrode(s) could also be understood as the opposing electrodes in each case. In particular an electrode could, without restriction, either be designated as a measuring electrode of a counter measuring electrode. The counter measuring electrode could especially be linked to ground in accordance with convention.

In general “a”, “an” etc. can be understood as a single item or as a plurality, especially in the sense of “at least one” or “one or more” etc., provided this is not explicitly excluded, e.g. by the expression “exactly one” etc.

A numerical specification can also specify precisely the specified number and also a usual tolerance range, provided this is not explicitly excluded.

### LIST OF REFERENCE CHARACTERS

1 Surface heater
2 Heat conductor section
3 Connecting section
4 Measuring electrode
5 Counter measuring electrode
11 Surface heater
12 Carrier substrate
13 Metallization
14 Contact element
15 Upper side
21 Surface heater
31 Surface heater
101 Surface heater
102 Carrier substrate
103 Carrier substrate
104 Carrier substrate
A Evaluation unit
C Capacitance
G Cooking utensil
GND Ground
H1 Household appliance
H2 Household appliance
H3 Household appliance
H4 Household appliance
K Capacitance measuring device
T Temperature
U Mains voltage

1-12. (canceled)

13. A surface heater for a household appliance, comprising:
an electrically insulating insulation layer having a permittivity which changes as a function of temperature.
at least one strip-shaped heat conductor applied to the electrically insulating insulation layer, and
at least one measuring electrode electrically insulated in relation to the at least one heat conductor and applied on a same side of the insulation layer as the heat conductor.

14. The surface heater of claim 13, wherein the measuring electrode is a strip-shaped measuring electrode, which is disposed in an area between two sections of the heat conductor running in parallel.

15. The surface heater of claim 13, further comprising at least one counter measuring electrode separated by the insulation layer from the at least one heat conductor and from the at least one measuring electrode.

16. The surface heater of claim 15, further comprising a planar electrically conductive carrier substrate for support of the at least one heat conductor via the insulation layer, said carrier substrate representing the counter measuring electrode.

17. The surface heater of claim 13, wherein the insulation layer is embodied as an electrically insulating carrier substrate.

18. The surface heater of claim 17, further comprising at least one counter measuring electrode disposed on a side of the electrically insulating carrier substrate facing away from the heat conductor.

19. The surface heater of claim 13, further comprising a planar, electrically conductive layer to define a counter measuring electrode, and an electrically insulating carrier substrate, said at least one heat conductor being disposed via the insulation layer on one side of the planar, electrically conductive layer, said electrically conductive layer having another side disposed on the electrically insulating carrier substrate.

20. The surface heater of claim 13, further comprising an electrically insulating carrier substrate having a side facing away from the at least one heat conductor, a counter measuring electrode placed upon said side of the carrier substrate, and at least one electrically conductive contact element received in the side of the carrier substrate and configured to electrically contact the counter measuring electrode.

21. A temperature measuring device for a surface heater, said temperature measuring device comprising a capacitance measuring device connected to at least one measuring electrode of the surface heater.

22. The temperature measuring device of claim 21, wherein the capacitance measuring device is connected between at least two measuring electrodes of the surface heater.

23. The temperature measuring device of claim 21, wherein the capacitance measuring device is connected to the at least one measuring electrode of the surface heater and to at least one counter measuring electrode of the surface heater, which at least one counter measuring electrode is separated from the at least one measuring electrode by an insulation layer.

24. A household appliance, comprising a system which includes:
at least one surface heater comprising an electrically insulating insulation layer having a permittivity which changes as a function of temperature, at least one strip-shaped heat conductor applied to the electrically insulating insulation layer, and at least one measuring electrode electrically insulated in relation to the at least one heat conductor and applied on a same side of the insulation layer as the heat conductor; and
at least one temperature measuring device comprising a capacitance measuring device connected to the at least one measuring electrode of the surface heater.

25. The household appliance of claim 24, constructed in the form of a cooking appliance for cooking food.

26. The household appliance of claim 24, wherein the capacitance measuring device is connected between at least two of said measuring electrode of the surface heater.

27. The household appliance of claim 24, wherein the surface heater has at least one counter measuring electrode which is separated from the at least one measuring electrode by the insulation layer, said capacitance measuring device being connected to the at least one measuring electrode and to the at least one counter measuring electrode.
